(19) United States
(12) Patent Application Publication
(10) Pub. No.: US 2018/0101920 A1
(43) Pub. Date: Apr. 12, 2018

(54) PROTECTION OF RIGHTS OF BEQUEATHERS AND BENEFICIARIES

(71) Applicant: ALEXANDER D. LANTSMAN, NEPTUNE, NJ (US)

(72) Inventor: ALEXANDER D. LANTSMAN, NEPTUNE, NJ (US)

(21) Appl. No.: 15/289,896

(22) Filed: Oct. 10, 2016

(51) Int. Cl. G06Q 50/18; G06Q 40/08; G06Q 40/06

(52) U.S. Cl. CPC G06Q 50/186; G06Q 40/06; G06Q 40/08

(57) ABSTRACT

Acceptance, storage and confidentiality are provided to (i) sealed packages containing notes disclosing location and accessibility of documents of Will/Testament, Trust(s) or Payable/Transferable-on-Death assets of a bequeather, or sealed packages containing the documents, copies or portions thereof, and (ii) an enclosure containing instructions for disposing of the packages after death of the bequeather. Upon obtaining an official confirmation that the bequeather is a deceased person or by a court order, the enclosure is opened and the instructions of the bequeather are fulfilled.

### BACKGROUND OF THE INVENTION

### 1. Technical Field

The present invention relates to the field of financial services and, in particular, to techniques for protecting rights of bequeathers and their beneficiaries.

### 2. Description of the Related Art

In many jurisdictions, to assure proper implementation of wishes of bequeathers regarding disposal of their assets after death, probate courts recognize only executed on paper hand-signed and witnessed originals or court-certified copies of Wills/Testaments documents further meeting specific requirements for their physical integrity and assembly.

Therefore, a bequeather is often concerned that their Will/Testament may be lost or corrupted/invalidated during or after their lifetime, as well as that content thereof may become prematurely known to the beneficiaries or others, thus compromising confidentiality of the Will/Testament. Additionally, the bequeather is commonly concerned that, after their death, information about other inheritable assets may not be available, in a timely manner, to beneficiaries, estate executors, trustees or a probate court.

Correspondingly, the beneficiaries could be concerned that they may not be informed of death of their bequeather or if financial instruments wherein they are named by the bequeather were properly preserved and remain valid.

### SUMMARY OF ILLUSTRATIVE EMBODIMENTS

Techniques for protecting rights of bequeathers and beneficiaries are disclosed. In one embodiment, a bequeather provides to an entrusted institution (i) sealed and selectively marked packages containing notes disclosing location and accessibility of documents of at least one of their Will/Testament, Payable/Transferable-on-Death asset(s) or Trust(s) and (ii) a sealed and marked enclosure containing instructions for disposing of the packages after death of the bequeather. In other embodiment, the bequeather provides to the entrusted institution pre-selected combinations of these documents, copies or portions thereof and the enclosure. Upon acceptance of follow-up correspondence, outdated packages or enclosure are returned to the bequeather.

Thereafter, the institution monitors official records, verifies public notices, and make inquiries if the bequeather is a deceased person. Upon confirming an event of death, perishing or disappearance of the bequeather or by a court order, the institution opens the enclosure and fulfilling the instructions of the bequeather.

Various other aspects and embodiments of the invention are described in further detail below. It has been contemplated that features of one embodiment of the invention may be incorporated in other embodiments thereof without further recitation.

The Summary is neither intended nor should it be construed as being representative of the full extent and scope of the present invention, which these and additional aspects will become apparent from the detailed description and appended drawings. The novel features believed being characteristic of the present invention are set forth in the appended claims.

### BRIEF DESCRIPTION OF THE DRAWINGS

FIG. 1 is a high-level diagram illustrating a method for protecting rights of bequeathers and beneficiaries in one or more embodiments of the invention. Images and legends in FIG. 1 are simplified for illustrative purposes and brevity.

### DETAILED DESCRIPTION OF ILLUSTRATIVE EMBODIMENTS

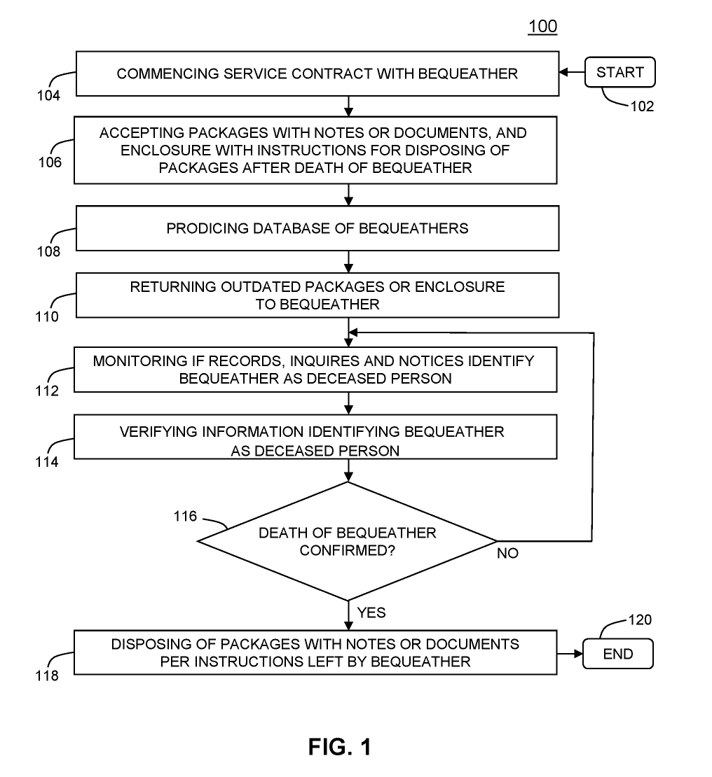

With reference now to FIG. 1, there is depicted a high-level diagram illustrating a method 100 for protecting rights of bequeathers and beneficiaries in one or more embodiments of the invention. The method 100 is facilitated by a legal entity entrusted by a bequeather. Herein, such entrusted entity, when performing steps of the method 100 alone or in a combination with other legal entities or individuals, is referred to as “Entity”. Illustratively, the Entity may be a financial services company, a bank, an insurance company, a law firm, etc. In an alternate embodiment, the Entity may be a part of or associated with a governmental institution or agency.

A bequeather generally assigns rights to inherit the entirety or portions of their assets to beneficiaries named in documents of financial instruments such as a Will/Testament, Trusts or Payable-on-Death/Transferable-on-Death (POD/TOD) assets. The terms “bequeather” is used herein in reference to a testator/testatrix, trustor, or owner of the POD/TOD assets. Correspondingly, the term “beneficiary” is used herein in reference to a person or legal entity named by the bequeather as a recipient of a portion of assets thereof in a most recent (also known as “last”) edition of the documents, wherein amounts/percentages of their respective inheritances are identified or stipulated.

The POD/TOD assets generally include bank, brokerage or investment accounts, life insurance policies, retirement accounts (e.g., IRA, 401k, Keogh, etc.), annuities, royalties, copyrights, contracts, deeds, loans, shareholder/partnership/ownership agreements, lease/rent agreements, stock options agreements, severances/pension agreements, inheritance rights, etc.

The terms “Will/Testament” and “Trust” are collectively used herein in reference to all types of the respective financial instruments of the bequeather. Illustrative examples include a Last and Testament Will, a Statutory Will, a Pour-Over Will, a Holographic Will, a Living Trust, a Revocable Trust, an Irrevocable Trust, a Testamentary Trust, and a Charitable Trust.

The method 100 begins at step 102 and proceeds to step 104. At step 104, the bequeather establishes secure communications with the Entity via a website of the Entity or by mail. Herein, the term “mail” is used in reference to all types of physical deliveries provided by a commercial delivery service, such as US Mail, UPS, etc.

The Entity generally maintains a website supporting Graphical User Interface and enabling secure (e.g., encrypted and/or requiring positive authentication and identification) transmissions between the bequeather and the Entity. Additionally, the website may facilitate communications with individuals or entities reporting death, perishing or disappearance of the bequeather (discussed in reference to step 112), as well as serve as a source of information for general public about the Entity, provided services, fees, etc.

In one embodiment, the Entity provides the bequeather with unique authenticating and identifying information (e.g., user name, password(s), docket number or other alpha-numerical identifier, etc.) and, after establishing the secure communication, the bequeather provides their contact data to the Entity. Herein, the terms “information” and “data” are used interchangeably.

The bequeather and Entity commence a contract for services of the Entity. The Entity charges the bequeather for provided services. The charges may include filing and maintenance fees, among other fees. For particular bequeathers (e.g., wounded veterans of the Military or Police, etc.), the Entity may reduce or eliminate some of the fees.

Contact data of the bequeather generally includes their full name, an address(es) of residence and/or estate, an address(es) for confidential communications, date and place of birth, numbers of government-issued identifications (e.g., Social Security, passport, military ID card, driver license, etc.), phone/fax numbers or e-mail addresses. The Entity may provide forms or templates for entering contact data of the bequeather or their intended addressees (discussed in reference to steps 106, 110 and 118).

Additionally, the bequeather may provide the Entity with authorizations required for fulfilling terms of the contract in particular jurisdictions of residence or estate of the bequeather. For example, such authorizations may allow the Entity (i) operate for a benefit of the bequeather, (ii) inquire in public records if the bequeather was identified as a deceased person, or (iii) apply for and obtain Death Certificate (or an equivalent thereof) of the bequeather from a respective authority, and the like. Alternatively, such authorizations are provided by the bequeather to the Entity by a separate mail or digital correspondence(s).

The Entity may require from the bequeather presenting of one or several forms of positive identification (e.g., paper/digital images of the government-issued identifications) as a proof that provided to the Entity data, authorizations or correspondence were prepared during lifetime of the bequeather.

For delivery of tangible correspondences the bequeather and Entity generally use traceable mail (e.g., certified, registered or insured mail, and the like), preferably requiring a proof of receipt and having pre-paid return provisions for failed deliveries. Particular deliveries may be performed in person or by an agent. In one embodiment, all tangible correspondences to/from the Entity are processed at a facility having a mailing address which is different from other mailing addresses used by the Entity.

At step 106, the Entity accepts and provides secure storage for correspondence received from the bequeather.

In one embodiment, the correspondence includes sealed and selectively marked packages (e.g., envelopes, cartons, etc.) containing (i) notes disclosing location and accessibility (e.g., code of a safe, etc.) of documents of at least one of Will/Testament, POD/TOD assets or Trust(s) of the bequeather, and (ii) a sealed and marked enclosure (e.g., envelope) containing instructions for disposing of the packages after death of the bequeather.

In other embodiment, the correspondence includes sealed and selectively marked packages containing (i) pre-selected combinations of the documents, copies or portions thereof, and (ii) instructions for disposing of these packages after death of the bequeather. A particular package may include all or only some types of originals or copies of the documents, either in their entirety or portions thereof. Herein, the term “original” is used in reference to an executed on paper articles having hand-written signature(s) of their respective signatory(s).

Optionally, the correspondence may include some or all authorizations (discussed in reference to step 104) and a listing of contents.

The Entity preserves confidentiality and does not edit or modify any portion of the received correspondence, as well as does not open/unseal the sealed articles or change their form or appearance. In particular, the Entity: (i) does not review contents of the enclosure until obtaining an official confirmation of death, perishing or disappearance of the bequeather or by a court order (discussed in reference to step 118), and (ii) does not review or copy contents of the packages.

Compliance of contents of the enclosure, packages or other articles of the correspondence with requirements of relevant institutions or courts (e.g., a probate court having jurisdiction over municipality of residence or estate of the bequeather) is the sole responsibility of the bequeather. Correspondingly, the Entity does not provide a legal advice to the bequeather on content of the correspondence or packages, enclosure or other articles therein.

Each package is dated with a date of its sealing or mailing the correspondence to the Entity and labeled with names of the bequeather and an intended addressee of the package. Additionally, the package may be labeled with (i) the identifier/docket number assigned, at step 104, to the bequeather by the Entity and/or (ii) an alpha-numerical identifier assigned to the addressee by the bequeather in their instructions (discussed in reference to step 118).

The enclosure is dated with a date of its sealing or mailing the correspondence to the Entity and labeled with the name of the bequeather. Additionally or alternatively, the enclosure may be labeled with the docket number assigned to the bequeather and/or a notice “Instructions”. The enclosure generally includes the instructions of the bequeather, which are printed on paper, dated, signed, witnessed or notarized. The Entity may assist the bequeather with forms/templates for mailing addresses and contact data of addressees of the packages, and templates for labels.

The packages containing the notes generally include an original or copies thereof, which are printed on paper, dated, signed, witnessed or notarized. Additionally, these packages may include executed authorizations of the bequeather required in particular jurisdictions, e.g., an authorization for a person to open, after death of the bequeather, a safe deposit box or other storage or living space of the bequeather and remove or examine particular items stored therein.

The packages containing the pre-selected combinations of the original documents, codicils, copies or portions thereof may include different sets of such articles and the authorizations as determined by the bequeather for a particular addressee. Generally, such articles are printed on paper, dated, signed, witnessed, court-certified, certified or notarized.

In other embodiment, at least portions of contents of the enclosure and packages may be provided therein by the bequeather in a digital form using (i) non-rewriteable computer-readable media or (ii) rewriteable or non-rewriteable computer-readable media as files non-editable by a viewer (e.g., PDF files, etc.). Correspondingly, a combination of deliveries by mail and means of digital communications via the website of the Entity could also be envisioned.

The Entity provides to the bequeather a confirmation of receipt of the correspondence. The confirmation may be delivered to the bequeather by mail, traceable mail, electronically or otherwise and to any address identified by the bequeather at step 104 (e.g., e-mail/mailing address for confidential communications). In some embodiments, the confirmation is optional.

The confirmation generally includes a mail tracking number and a listing of contents of the correspondence, a listing and images of noticed damages and, optionally, images of the enclosure, packages and other contents, if any. The confirmation may be printed on paper, be in a digital form (e.g., stored on computer-readable media as non-editable by a recipient files), be securely transmitted to the bequeather, or securely available thereto on the website of the Entity.

The Entity securely stores and preserves the articles of the correspondence. Accidents involving breach of integrity or confidentiality of contents of the articles are promptly reported to the bequeather. An accident may also be reported to authorities (e.g., police or a probate court having jurisdiction over municipality of the place of the accident), and efforts be made to restore the affected articles to a condition satisfactory to the bequeather or authorities.

At step 108, the Entity develops a processor-readable database of bequeathers. In the database, the bequeather may be associated with one or several particular identifier, e.g., last name and/or the docket number (discussed above in reference to step 104). For each bequeather, the database generally includes, in a digital form: (i) contact data of the bequeather, (ii) listings and images of articles accepted by the Entity, (iii) listings and images of articles returned to the bequeather and/or disposed of to addressees thereof, (iv) records of bequeather-related activities of the Entity, and the like.

The bequeather-related data is generally stored for a pre-selected period of time (e.g., 10, 20 or more years). Information in the database may be encrypted or otherwise protected (e.g., portions of the database may have limited or no connectivity to the Internet, etc.).

At step 110, the Entity accepts from the bequeather follow-up correspondence(s), if any, and replaces outdated (i.e., previously accepted) articles in outgoing correspondence(s) to the bequeather. The bequeather may replace, update or supplement any portion of previous correspondence(s) on “as needed” basis any time during their lifetime.

When a follow-up correspondence includes more recently dated (i.e., newer) editions of the enclosure, all or particular packages, or other articles (e.g., authorizations for the Entity) than the ones being preserved at the Entity, respective outdated articles are returned intact back to the bequeather and replaced with the more recently dated editions thereof. As such, the Entity always possesses most recent editions of the packages enclosure, or authorizations.

The Entity provides confirmations of receipt of the follow-up correspondences and notices of returning the outdated articles. Generally, means of delivery and content of such confirmations and notices are similar to the ones provided for the correspondence discussed in reference to step 104. The returned articles are sent back to the bequeather by traceable mail requiring a proof of receipt and having pre-paid return provisions for failed deliveries.

At step 112, the Entity attempts to detect an event of death of the bequeather. Herein the term “death” is used in reference to an officially recognized or recorded event of death, perishing of disappearance of a person. In one embodiment, the Entity periodically monitors data and inquires in governmental or non-governmental public records or otherwise publicly available sources of information if the bequeather is/was listed or identified therein as a deceased person. The inquiries are conducted with pre-selected periodicity (e.g., once a week, month, etc.) and may be performed using Internet-enabled computers or manually, as well as by placing requests with respective sources of such information.

The inquiries generally include (i) performed by or on behalf of the Entity searches of published data (e.g., data available on the Internet or in print) establishing the event of death of the bequeather, and/or (ii) requests to sources of such data to provide the Entity or an authorized agent thereof with information if the bequeather is/was identified or listed as a deceased person.

The records may include public-domain information provided by or obtained from governmental and non-governmental sources. Examples of such sources include Social Security Death Master File, Military Records of Casualties, Death/Vital/Statistical records of States or municipalities, records of Funeral Services and medical institutions, mortuaries, coroners, police, and commercial data companies.

Additionally, the Entity accepts notices regarding the event of death of the bequeather received from individuals associated with or having knowledge of the bequeather, e.g., family members, relatives, acquaintances, employees, etc. To be convincing for the Entity, such notices are preferably accompanied by a valid (e.g., certified or notarized) copy of Death Certificate of the bequeather or an equivalent official confirmation of death, perishing or disappearance of the bequeather. Alternatively, the notices may contain data needed to the Entity or others for obtaining Death Certificate of the bequeather. In one embodiment, the Entity offers rewards to individuals providing information verifying the event of death of the bequeather.

Information collected by the Entity and, specifically, the data and notices identifying the bequeather as a deceased person is converted in a processor-readable format compatible with the database of the bequeathers (discussed in reference to step 108), and entered thereto.

At step 114, information establishing the event of death of the bequeather is analyzed by the Entity for completeness, consistency and accuracy. For example, portions of data obtained from different sources may be compared to one another and/or otherwise examined and verified, validity or reliability of particular notices, records or sources thereof may be inspected, cross-referenced, etc.

To reduce probability of an error, the Entity may attempt to contact the bequeather or contact members of estate thereof and inquire on correctness of the information regarding death of the bequeather. Additionally, the Entity may request the institution(s) issued Death Certificate or a confirmation of death of the bequeather to confirm authenticity of these documents.

At step 116, the method 100 queries if data identifying the bequeather as a deceased person is reasonably reliable (i.e., meets reliability and accuracy criteria of the Entity). If the query of step 116 is answered negatively, the method 100 proceeds back to step 112. If the query of step 116 is answered positively, the method 100 proceeds to step 118.

At step 118, the Entity opens the enclosure preserved therein (i.e., most recent, or “last”, edition of the enclosure), and fulfils the instructions left therein by the bequeather.

Using mailing addresses indicated in these instructions, the Entity selectively disposes of most recent, or “last”, editions of sealed packages preserved at the Entity to their intended addressees whose names or other alpha-numerical identifiers in the instructions match the ones marked by the bequeather on the respective packages. As such, the intended addressee of a particular package is identified by matching names or, alternatively, alpha-numerical identifiers in the instructions of the bequeather and marked by the bequeather on most recent edition of the package accepted by Entity.

In one embodiment, an event of opening the enclosure is dated, recorded and, optionally, performed in presence of a witness(es). Contents of the enclosure (i.e., instructions) are examined and copied without disassembling thereof (e.g., staples are left intact), and digital copies of a record of opening the enclosure and images of pages of the instructions are stored in the database of bequeather (discussed in reference to step 110).

In a preferred embodiment, the packages preserved at the Entity (i.e., most recent edition of the respective packages, as discussed in reference to steps 106, 110) are inspected for physical integrity. Thereafter, the uncompromised packages are disposed of by traceable mail requiring positive identification of the recipient and a proof of acceptance of the delivery, as well as having pre-paid provisions for returning failed deliveries back to the Entity.

In one embodiment, the packages are supplemented by a copy of an official confirmation of death, perishing or disappearance of the bequeather (e.g., copy of Death Certificate thereof) and/or contact information of a source of the confirmation. Prior to disposal of the packages, the Entity may verify correctness of mailing addresses and ability of the addressees to accept the deliveries by contacting them using provided phone/fax numbers and/or e-mail addresses.

Mail tracking numbers and, optionally, images of the mailed packages are recorded and stored in the database of bequeathers. By a way of fulfilling the instructions, alternatively or additionally, the Entity may use other means of delivery of the packages (e.g., couriers, personal pick-up by an addressee or agent thereof, etc.).

Returned packages may be reported to and/or forwarded by the Entity to alternate addressees or appointee(s) of the bequeather designated in the instructions (e.g., attorney, trustee, executor or member of estate of the bequeather, etc.). Unaccomplished deliveries, along with a copy of the contract and the instructions of the bequeather, are generally reported to and/or forwarded to a probate court of municipality of residence or estate of the bequeather for their discretion.

When physical conditions of the enclosure, contents thereof or a particular package is found unsatisfactory, such an accident is reported to an appointee named by the bequeather in the instructions or contract with the Entity or (ii) to authorities (e.g., police or a probation court having jurisdiction over municipality of the place of the accident), and efforts be made to restore the affected articles to a condition satisfactory to the appointee or the authorities.

In other embodiment, the Entity opens the enclosure by a court order. Such an order may arrive any time after acceptance of the correspondence (discussed in reference to step 106) by the Entity and include directives for fulfilling the instructions of the bequeather or delivery of all or some articles of the bequeather to the court or court-designated authority.

Upon completion of step 118, the method 100 ends at step 120.

In other embodiments, execution of portions of particular steps of the method 100 may be outsourced by the Entity to other legal entities or be performed by, or in cooperation with, contractors/sub-contractors or agents of the Entity.

Aspects of the present invention have been described with respect to steps of the method 100. However, the invention may alternatively be implemented as a system having facilities selectively adapted for implementing portions of steps of the method 100 and therefore representing an alternative embodiment of the invention.

Correspondingly, portions of steps of the method 100 may be presented in a form of processor-readable instructions embedded in computer-readable medium and defining features of the invention. A program product having such instructions, as well as signal-bearing media carrying the instructions also represent an alternative embodiment of the invention.

Although the present invention has been described herein with reference to particular preferred embodiments thereof, these embodiments are merely illustrative of the principles and applications of the invention. Therefore, modifications may be made to these embodiments and other arrangements may be devised without departing from the spirit and scope of the invention, which is defined by the appended claims.

1. A method of disposing of executed on paper documents on a pre-determined notice, comprising:
(a) providing in separate packages pre-selected combinations of the documents defined by a sender of the documents for delivery to addressees of the packages, marking each of the packages with a name of the sender and a name of an addressee of a package, and sealing the packages;
(b) preparing sender-signed instructions for disposing of the sealed packages on the pre-determined notice wherein the instructions include names and mailing addresses of the addressees of the packages, placing the instructions in an enclosure, marking the enclosure with the name of the sender, and sealing the enclosure; and
(c) providing the sealed packages and sealed enclosure by tangible mail to an entity adapted for:
unsealing the enclosure on the pre-determined notice and accessing the instructions; and
selectively disposing of the sealed packages to the marked thereon addressees at their mailing addresses included in the instructions.

2-7. (canceled)

8. The method of claim 1, wherein:
the documents comprise Will/Testament, Payable/Transferable-on-Death asset(s) or Trust(s) documents of the sender; and
the predetermined notice is a notice of death of the sender.

9. The method of claim 1, wherein:
the packages and enclosure are envelopes or cartons; and
the entity is an insurance company, a financial services company, or a delivery services company.

10. A method of disposing of executed on paper documents pre-defined by a bequeather for delivery after death of the bequeather, comprising:
(a) providing in separate packages pre-selected combinations of the documents defined by the bequeather for delivery to addressees of the packages, marking each of the packages with a name of the bequeather and a name of an addressee of a package, and sealing the packages;
(b) preparing bequeather-signed instructions for disposing of the sealed packages after death of the bequeather wherein the instructions include names and mailing addresses of the addressees of the packages, placing the instructions in an enclosure, marking the enclosure with the name of the bequeather, and sealing the enclosure; and
(c) providing the sealed packages and sealed enclosure by tangible mail to an entity adapted for:
unsealing the enclosure on a notice of death of the bequeather and accessing the instructions; and
selectively disposing of the sealed packages to the marked thereon addressees at their mailing addresses included in the instructions.

11-15. (canceled)

16. The method of claim 10, wherein:
the documents comprise Will/Testament, Payable/Transferable-on-Death asset(s) or Trust(s) documents of the bequeather; and
the notice comprises Death Certificate of the bequeather.

17. The method of claim 10, wherein:
the packages and enclosure are envelopes or cartons; and
the entity is an insurance company, a financial services company, or a delivery services company.

18-20. (canceled)
